(19) United States
(12) Patent Application Publication
(10) Pub. No.: US 2012/0260185 A1
(43) Pub. Date: Oct. 11, 2012

(54) PATH LENGTH SELECTOR

(75) Inventors: Theodore Nicholas Choc, Palo Alto, CA (US); Hongxu Cai, Mountain View, CA (US)

(73) Assignee: Google Inc.

(21) Appl. No.: 13/084,549

(22) Filed: Apr. 11, 2011

(51) Int. Cl. G06F 3/01

(52) U.S. Cl. 715/738

(57) ABSTRACT

Methods, systems, and apparatuses, including computer programs encoded on a computer storage medium for providing data related to conversion paths. In one aspect, conversion path data for a plurality of conversion paths is received. The conversion path data includes a path length measure for each conversion path in the plurality of conversion paths. One or more groups of paths length measures and an aggregate performance measure for each path length measure group are determined. The aggregate performance measure can be a total number of conversions. Instructions for displaying the list of the one or more groups of path length measures, corresponding aggregate measures, and a graphical representation based on the one or more groups and aggregate performance are provided. The graphical representation can be a histogram.

### BACKGROUND

The Internet provides access to a wide variety of content. For instance, images, audio, video, and web pages for a myriad of different topics are accessible through the Internet. The accessible content provides an opportunity to place advertisements. Advertisements can be placed within content, such as a web page, image or video, or the content can trigger the display of one or more advertisements, such as presenting an advertisement in an advertisement slot.

Advertisers decide which ads are displayed within particular content using various advertising management tools. These tools also allow an advertiser to track the performance of various ads or ad campaigns. The parameters used to determine when to display a particular ad can also be changed using advertising management tools.

The data that is used to generate the performance measures for the advertiser generally includes all data that is available. This data usually includes a combination of data from multiple servers. The amount of the combined data is large enough that performance measures generated from the data can be used to provide an efficient way of understanding the data. Processing of the data to generate useful and accurate performance measures involves a number of obstacles. For instance, if a performance measure is based upon a user's actions over a period of time, the user's actions should be tracked. A cookie can be used to track a user's actions over a period of time. However, if this cookie is removed during the period of time, collection of accurate data tracking the user's actions may be disrupted. The data can contain record user actions that include various actions that are significant to an advertiser. These actions, which can be any recordable event, are called conversions. Identifying other actions that contribute to the occurrence of conversions is valuable. The data, however, contains numerous actions that could be associated with conversions. In addition, the data may also contain information regarding user actions that do not contribute to any recorded conversions. Thus, processing the data to provide accurate and reliable performance measures based upon all the available information regarding user actions has a number of challenges.

### SUMMARY

One approach to providing data related to conversion paths involves a method. The method includes receiving user interaction data. The user interaction data specifies user interaction with content items and conversion items, and a conversion item is one or more user action that satisfies one or more predetermined conversion criteria. The method further includes receiving conversion data including conversion path data for a plurality of conversion paths. Each conversion path includes user interaction data prior to and including a conversion event. Conversion path data includes a path length measure for each conversion path in the plurality of conversion paths. The method further includes determining one or more groups of path length measures. The method further includes determining an aggregate performance measure for each path length measure group. The method further includes generating a list of the one or more groups of path length measures and corresponding aggregate performance measures.

Another approach to providing data related to conversion paths involves at least one non-transitory or tangible computer readable storage medium encoded with processor-executable instructions that, when executed by at least one processor, perform a method. The method includes receiving user interaction data. The user interaction data specifies user interaction with content items and conversion items, and a conversion item is a user action that satisfies a predetermined conversion criteria. The method further includes receiving conversion data including conversion path data for a plurality of conversion paths. Each conversion path includes user interaction data prior to and including a conversion event. Conversion path data includes a path length measure for each conversion path in the plurality of conversion paths. The method further includes determining one or more groups of path length measures. The method further includes determining an aggregate performance measure for each path length measure group. The method further includes generating a list of the one or more groups of path length measures and corresponding aggregate performance measures. The method further includes generating a visual representation of the one or more groups of path length measures and corresponding aggregate performance measures.

Another approach to providing data related to conversion paths is an apparatus. The apparatus includes at least one communications interface, at least one memory to store processor-executable instructions, and at least one processor communicatively coupled to the at least one communications interface and the at least one memory. Upon execution of the processor-executable instructions, the at least one processor receives user interaction data. The user interaction data specifies user interaction with content items and conversion items, and a conversion item is a user action that satisfies a predetermined conversion criteria. The at least one processor further receives conversion data including conversion path data for a plurality of conversion paths. Each conversion path includes user interaction data prior to and including a conversion event. Conversion path data includes a path length measure for each conversion path in the plurality of conversion paths. The at least one processor further determines one or more groups of path length measures, determines an aggregate performance measure for each path length measure group, and generates a list of the one or more groups of path length measures and corresponding aggregate performance measures. The at least one processor further provides instructions to display the list of the one or more groups of path length measures including instructions to display a graphical representation based upon the list of the one or more groups of path length measures and corresponding aggregate performance measures.

### BRIEF DESCRIPTION OF THE DRAWINGS

Various embodiments taught herein are illustrated by way of example, and not by way of limitation, in the figures of the accompanying drawings, in which:

FIG. 1 is a block diagram of an example environment in which an advertisement management system manages advertising services, according to an illustrative embodiment;

FIG. 2 is a flow diagram of a process for updating user interaction log data, according to an illustrative embodiment;

FIG. 3 is a block diagram that illustrates user interaction data being updated during a user interaction log data update process, according to an illustrative embodiment;

FIG. 4 illustrates exemplary conversion paths, according to an illustrative embodiment;

FIG. 5 illustrates an exemplary grouping of conversion paths with a conversion path length greater than two, according to an illustrative embodiment;

FIGS. 6A-6C illustrate exemplary user interfaces displaying a list and a visual representation of groups of path length measures and corresponding performance measures, according to an illustrative embodiment;

FIGS. 7A-7H illustrate exemplary user interfaces displaying performance data based on a selection of a specific group of path length measures, according to an illustrative embodiment;

FIG. 8 is a flow diagram that illustrates providing performance data using conversion path length, according to an illustrative embodiment; and

FIG. 9 is a block diagram illustrating a general architecture for a computer system that may be employed to implement various elements of the system shown in FIG. 1, according to an illustrative embodiment.

It will be recognized that some or all of the figures are schematic representations for purposes of illustration and do not necessarily depict the actual relative sizes or locations of the elements shown. The figures are provided for the purpose of illustrating one or more implementations with the explicit understanding that they will not be used to limit the scope or the meaning of the claims. Like reference numbers and designations in the various drawings indicate like elements.

### DETAILED DESCRIPTION

Following below are more detailed descriptions of various concepts related to, and embodiments of, methods, apparatuses and systems for analyzing conversion path data using path length measures. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

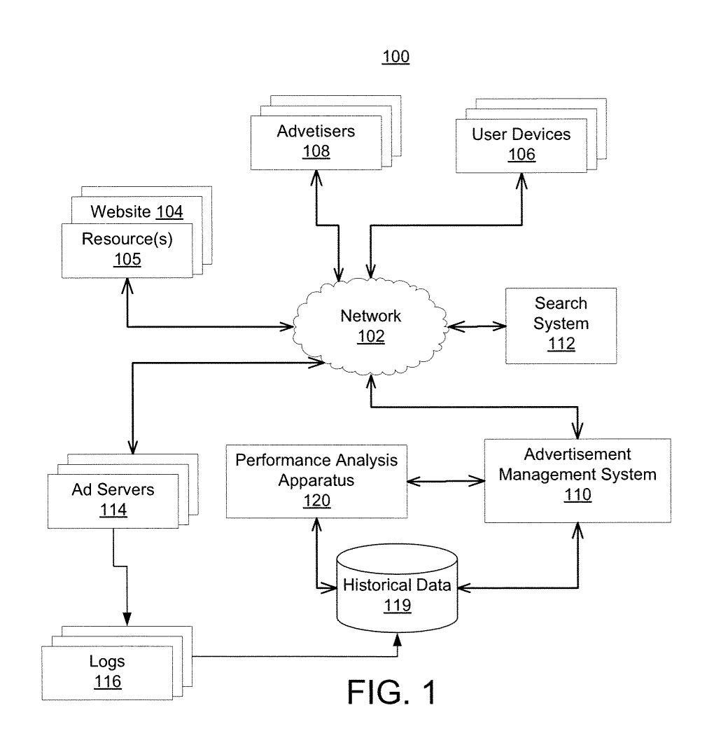

Using tools provided by an advertisement management system 110 (FIG. 1), advertisers can analyze user interactions data with online content. The user interaction data can include a collection of conversion paths that represent events involving users prior to converting (i.e., prior to performing an action desired by the advertiser, such as purchasing a product or service). User interfaces can be provided to enable advertisers to filter conversion paths for further analysis. Such user interfaces can allow users to select data to analyze based on a path length measure. Different path lengths can represent different user behavior. The user interfaces can provide the advertisers with a list of potential path length options along with information regarding how each path length contributes to a particular performance metric (e.g., a number of conversions having a given path length), as well as a visual presentation of the path length options and their contribution to the performance metric.

As used throughout this document, user interactions include any presentation of content to a user and any subsequent affirmative actions or non-actions (collectively referred to as “actions” unless otherwise specified) that a user takes in response to presentation of content to the user (e.g., selections of the content following presentation of the content, or non-selections of the content following the presentation of the content). Thus, a user interaction does not necessarily require a selection of the content (or any other affirmative action) by the user.

User interaction measures can include one or more of time lag measures (i.e., measures of time from one or more specified user interactions to a conversion), path length measures (i.e., quantities of user interactions that occurred prior to conversions), user interaction paths (i.e., sequences of user interactions that occurred prior to the conversion), assist interaction measures (i.e., quantities of particular user interactions that occurred prior to the conversion), and assisted conversion measures (i.e., quantities of conversions that were assisted by specified content).

FIG. 1 is a block diagram of an example environment in which an advertisement management system manages advertising services in accordance with an illustrative embodiment. The example environment 100 includes a network 102, such as a local area network (LAN), a wide area network (WAN), the Internet, or a combination thereof. The network 102 connects websites 104, user devices 106, advertisers 108, and an advertisement management system 110. The example environment 100 may include many thousands of websites 104, user devices 106, and advertisers 108.

A website 104 includes one or more resources 105 associated with a domain name and hosted by one or more servers. An example website is a collection of web pages formatted in hypertext markup language (HTML) that can contain text, images, multimedia content, and programming elements, such as scripts.

A resource 105 is any data that can be provided over the network 102. A resource 105 is identified by a resource address that is associated with the resource 105, such as a uniform resource locator (URL). Resources 105 can include web pages, word processing documents, portable document format (PDF) documents, images, video, programming elements, interactive content, and feed sources, to name only a few. The resources 105 can include content, such as words, phrases, images and sounds, that may include embedded information (such as meta-information in hyperlinks) and/or embedded instructions. Embedded instructions can include code that is executed at a user's device, such as in a web browser. Code can be written in languages such as JavaScript® or ECMAScript®.

A user device 106 is an electronic device that is under control of a user and is capable of requesting and receiving resources 105 over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can include data specifying a portion of the resource or a portion of a user display (e.g., a presentation location of a pop-up window or in a slot of a web page) in which advertisements can be presented. These specified portions of the resource 105 or user display are referred to as advertisement slots.

To facilitate searching of the vast number of resources 105 accessible over the network 102, the environment 100 can include a search system 112 that identifies the resources 105 by crawling and indexing the resources 105 provided on the websites 104. Data about the resources 105 can be indexed based on the resource 105 with which the data is associated. The indexed and, optionally, cached copies of the resources 105 are stored in a search index (not shown).

User devices 106 can submit search queries to the search system 112 over the network 102. In response, the search system 112 accesses the search index to identify resources 105 that are relevant to the search query. In one illustrative embodiment, a search query includes one or more keywords. The search system 112 identifies the resources 105 that are responsive to the query, provides information about the resources 105 in the form of search results and returns the search results to the user devices 106 in search results pages. A search result can include data generated by the search system 112 that identifies a resource 105 that is responsive to a particular search query, and can include a link to the resource 105. An example search result can include a web page title, a snippet of text or a portion of an image extracted from the web page 104, a rendering of the resource 105, and the URL of the web page 104. Search results pages can also include one or more advertisement slots in which advertisements can be presented.

A search result page can be sent with a request from the search system 112 for the web browser of the user device 106 to set an HTTP (HyperText Transfer Protocol) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifier can be anonymized and is not connected with user names. Because HTTP is a stateless protocol, the use of cookies allows an external service, such as the search system 112 or other system, to track particular actions and status of a user over multiple sessions. A user may opt out of tracking user actions, for example, by disabling cookies in the browser's settings.

When a resource 105 or search results are requested by a user device 106 or provided to the user device 106, the advertisement management system 110 receives a request for advertisements to be provided with the resource 105 or search results. The request for advertisements can include characteristics of the advertisement slots that are defined for the requested resource 105 or search results page, and can be provided to the advertisement management system 110. For example, a reference (e.g., URL) to the resource 105 for which the advertisement slot is defined, a size of the advertisement slot, and/or media types that are available for presentation in the advertisement slot can be provided to the advertisement management system 110. Similarly, keywords (i.e., one or more words that are associated with content) associated with a requested resource 105 (“resource keywords”) or a search query for which search results are requested can also be provided to the advertisement management system 110 to facilitate identification of advertisements that are relevant to the resource 105 or search query.

Based on data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries. In some implementations, advertisements having targeting keywords that match the resource keywords, the search query, or portions of the search query are selected as eligible advertisements by the advertisement management system 110.

The advertisement management system 110 selects an eligible advertisement for each advertisement slot of a resource 105 or of a search results page. The resource 105 or search results page is received by the user device 106 for presentation by the user device 106. User interaction data representing user interactions with presented advertisements can be stored in a historical data store 119. For example, when an advertisement is presented to the user via an ad server 114, data can be stored in a log file 116. This log file 116, as more fully described below, can be aggregated with other data in the historical data store 119. Accordingly, the historical data store 119 contains data representing the advertisement impression. For example, the presentation of an advertisement is stored in response to a request for the advertisement that is presented. For example, the ad request can include data identifying a particular cookie, such that data identifying the cookie can be stored in association with data that identifies the advertisement(s) that were presented in response to the request. In some implementations, the data can be stored directly to the historical data store 119.

Similarly, when a user selects (i.e., clicks) a presented advertisement, data representing the selection of the advertisement can be stored in the log file 116, a cookie, or the historical data store 119. In some implementations, the data is stored in response to a request for a web page that is linked to by the advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers that represent a corresponding user device with which the user interactions were performed. For example, in some implementations, user interaction data can be associated with one or more cookies. Each cookie can include content which specifies an initialization time that indicates a time at which the cookie was initially set on the particular user device 106.

The log files 116, or the historical data store 119, also store references to advertisements and data representing conditions under which each advertisement was selected for presentation to a user. For example, the historical data store 119 can store targeting keywords, bids, and other criteria with which eligible advertisements are selected for presentation. Additionally, the historical data store 119 can include data that specifies a number of impressions for each advertisement and the number of impressions for each advertisement can be tracked, for example, using the keywords that caused the advertisement impressions and/or the cookies that are associated with the impressions. Data for each impression can also be stored so that each impression and user selection can be associated with (i.e., stored with references to and/or indexed according to) the advertisement that was selected and/or the targeting keyword that caused the advertisement to be selected for presentation.

The advertisers 108 can submit, to the advertisement management system 110, campaign parameters (e.g., targeting keywords and corresponding bids) that are used to control distribution of advertisements. The advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements. The campaign performance report can also provide a total cost, a cost-per-click, and other cost measures for the advertisement over a specified period of time. For example, an advertiser may access a performance report that specifies that advertisements distributed using the phrase match keyword “hockey” have received 1,000 impressions (i.e., have been presented 1,000 times), have been selected (e.g., clicked) 20 times, and have been credited with 5 conversions. Thus, the phrase match keyword hockey can be attributed with 1,000 impressions, 20 clicks, and 5 conversions.

As described above, reports that are provided to a particular content provider can specify performance measures measuring user interactions with content that occur prior to a conversion. A conversion occurs when a user performs a specified action, and a conversion path includes a conversion and a set of user interactions occurring prior to the conversion by the user. Any user interaction or user interactions can be deemed a conversion. What constitutes a conversion may vary from case to case and can be determined in a variety of ways. For example, a conversion may occur when a user clicks on an advertisement, is referred to a web page or website, and then consummates a purchase there before leaving the web page or website. As another example, a conversion may occur when a user spends more than a given amount of time on a particular website. Data from multiple user interactions can be used to determine the amount of time at the particular website.

Actions that constitute a conversion can be specified by each advertiser. For example, each advertiser can select, as a conversion, one or more measurable/observable user actions such as, for example, downloading a white paper, navigating to at least a given depth of a website, viewing at least a certain number of web pages, spending at least a predetermined amount of time on a website or web page, or registering on a website. Other actions that constitute a conversion can also be used.

To track conversions (and other interactions with an advertiser's website), an advertiser can include, in the advertiser's web pages, embedded instructions that monitor user interactions (e.g., page selections, content item selections, and other interactions) with advertiser's website, and can detect a user interaction (or series of user interactions) that constitutes a conversion. In some implementations, when a user accesses a web page, or another resource, from a referring web page (or other resource), the referring web page (or other resource) for that interaction can be identified, for example, by execution of a snippet of code that is referenced by the web page that is being accessed and/or based on a URL that is used to access the web page.

For example, a user can access an advertiser's website by selecting a link presented on a web page, for example, as part of a promotional offer by an affiliate of the advertiser. This link can be associated with a URL that includes data (i.e., text) that uniquely identifies the resource from which the user is navigating. For example, the link http://www.example.com/homepage%affiliate_identifier % promotion_{—}1 specifies that the user navigated to the example.com web page from a web page of the affiliate that is associated with the affiliate identifier number that is specified in the URL, and that the user was directed to the example.com web page based on a selection of the link that is included in the promotional offer that is associated with promotion_{—}1. The user interaction data for this interaction (i.e., the selection of the link) can be stored in a database and used, as described below, to facilitate performance reporting.

When a conversion is detected for an advertiser, conversion data representing the conversion can be transmitted to a data processing apparatus (“analytics apparatus”) that receives the conversion data, and in turn, stores the conversion data in a data store. This conversion data can be stored in association with one or more cookies for the user device that was used to perform the user interaction, such that user interaction data associated with the cookies can be associated with the conversion and used to generate a performance report for the conversion.

Typically, a conversion is attributed to a targeting keyword when an advertisement that is targeted using the targeted keyword is the last clicked advertisement prior to the conversion. For example, advertiser X may associate the keywords “tennis,” “shoes,” and “Brand-X” with advertisements. In this example, assume that a user submits a first search query for “tennis,” the user is presented a search result page that includes advertiser X's advertisement, and the user selects the advertisement, but the user does not take an action that constitutes a conversion. Assume further that the user subsequently submits a second search query for “Brand-X,” is presented with the advertiser X's advertisement, the user selects advertiser X's advertisement, and the user takes action that constitutes a conversion (e.g., the user purchases Brand-X tennis shoes). In this example, the keyword “Brand-X” will be credited with the conversion because the last advertisement selected prior to the conversion (“last selected advertisement”) was an advertisement that was presented in response to the “Brand-X” being matched.

Providing conversion credit to the keyword that caused presentation of the last selected advertisement (“last selection credit”) prior to a conversion is a useful measure of advertisement performance, but this measure alone does not provide advertisers with data that facilitates analysis of a conversion cycle that includes user exposure to, and/or selection of, advertisements prior to the last selected advertisement. For example, last selection credit measures alone do not specify keywords that may have increased brand or product awareness through presentation of advertisements that were presented to, and/or selected by, users prior to selection of the last selected advertisement. However, these advertisements may have contributed significantly to the user subsequently taking action that constituted a conversion.

In the example above, the keyword “tennis” is not provided any credit for the conversion, even though the advertisement that was presented in response to a search query matching the keyword “tennis” may have contributed to the user taking an action that constituted a conversion (e.g., making a purchase of Brand-X tennis shoes). For instance, upon user selection of the advertisement that was presented in response to the keyword “tennis” being matched, the user may have viewed Brand-X tennis shoes that were available from advertiser X. Based on the user's exposure to the Brand-X tennis shoes, the user may have subsequently submitted the search query “Brand-X” to find the tennis shoes from Brand-X. Similarly, the user's exposure to the advertisement that was targeted using the keyword “tennis,” irrespective of the user's selection of the advertisement, may have also contributed to the user subsequently taking action that constituted a conversion (e.g., purchasing a product from advertiser X). Analysis of user interactions, with an advertiser's advertisements (or other content), that occur prior to selection of the last selected advertisement can enhance an advertiser's ability to understand the advertiser's conversion cycle.

A conversion cycle is a period that begins when a user is presented an advertisement and ends at a time at which the user takes action that constitutes a conversion. A conversion cycle can be measured and/or constrained by time or actions and can span multiple user sessions. User sessions are sets of user interactions that are grouped together for analysis. Each user session includes data representing user interactions that were performed by a particular user and within a session window (i.e., a specified period). The session window can be, for example, a specified period of time (e.g., 1 hour, 1 day, or 1 month) or can be delineated using specified actions. For example, a user search session can include user search queries and subsequent actions that occur over a 1 hour period and/or occur prior to a session ending event (e.g., closing of a search browser).

Analysis of a conversion cycle can enhance an advertiser's ability to understand how its customers interact with advertisements over a conversion cycle. For example, if an advertiser determines that, on average, an amount of time from a user's first exposure to an advertisement to a conversion is 20 days, the advertiser can use this data to infer an amount of time that users spend researching alternative sources prior to converting (i.e., taking actions that constitute a conversion). Similarly, if an advertiser determines that many of the users that convert do so after presentation of advertisements that are targeted using a particular keyword, the advertiser may want to increase the amount of money that it spends on advertisements distributed using that keyword and/or increase the quality of advertisements that are targeted using that particular keyword.

Measures of user interactions that facilitate analysis of a conversion cycle are referred to as conversion path performance measures. A conversion path is a set of user interactions by a particular user prior to and including a conversion by the particular user. Conversion path performance measures specify durations of conversion cycles, numbers of user interactions that occurred during conversion cycles, paths of user interactions that preceded a conversion, numbers of particular user interactions that occurred preceding conversions, as well as other measures of user interaction that occurred during conversion cycles, as described in more detail below.

The advertisement management system 110 includes a performance analysis apparatus 120 that determines conversion path performance measures that specify measures of user interactions with content items during conversion cycles. The performance analysis apparatus 120 tracks, for each advertiser, user interactions with advertisements that are provided by the advertiser, determines (i.e., computes) one or more conversion path performance measures, and provides data that cause presentation of a performance report specifying at least one of the conversion path performance measures. Using the performance report, the advertiser can analyze its conversion cycle, and learn how each of its keywords cause presentation of advertisements that facilitate conversions, irrespective of whether the keywords caused presentation of the last selected advertisement. In turn, the advertiser can adjust campaign parameters that control distribution of its advertisements based on the performance report.

Configuration options can be offered to reduce bias in performance reports. Without configuration options, some performance reports can be biased, such as towards short conversion paths. For example, a performance report can be biased towards short conversion paths if data used as a basis for the report includes a percentage of partial conversion paths which is higher than a threshold percentage. A partial conversion path is a conversion path in which some but not all user interaction data for a user is associated with a conversion. A partial conversion path can be included in a report if, for example, the report is generated using a reporting period which is less then the length of a typical conversion cycle for the advertiser who requested the report.

A reporting period determines the maximum length (in days) of a reported conversion cycle because additional data outside of the reporting period is not used to generate the report. A performance report can be based on a reporting period (i.e., lookback window), such that user interactions prior to the reporting period are not considered part of the conversion cycle when generating the report. Such a reporting period is referred to as a “lookback window”. For example, when generating a report with a lookback window of thirty days, available user interaction data representing user actions that occurred between July 1 and July 31 of a given year would be available for a conversion that occurred on July 31 of that year.

If a default lookback window (e.g., thirty days) is used, the performance report can be biased towards short conversion paths if the typical conversion cycle length for a product associated with the report is greater than the default lookback window. For instance, in the example above, a typical conversion cycle for “Brand-X” tennis shoes may be relatively short (e.g., thirty days) as compared to a conversion cycle for a more expensive product, such as a new car. A new car may have a much longer conversion cycle (e.g., ninety days).

Different advertisers or different products for an advertiser can have different associated conversion cycle lengths. For example, an advertiser that sells low cost (e.g., less than $100) products may specify a lookback window of 30 days, while an advertiser that sells more expensive products (e.g., at least $1000) may specify a lookback window of 90 days.

In some implementations, an advertiser 108 can specify a lookback window to use when requesting a performance report, such as by entering a number of days or by selecting a lookback window from a list of specific lookback windows (e.g., thirty days, sixty days, ninety days). Allowing an advertiser to configure the lookback window of their performance reports enables the advertiser to choose a lookback window that corresponds to conversion cycles of their products. Allowing lookback window configuration also enables advertisers to experiment with different lookback windows, which can result in the discovery of ways to improve conversion rates.

Other factors can contribute to reporting on partial conversion paths. For example, as mentioned above, user interaction data used as a basis for a report can be associated with unique identifiers that represent a user device with which the user interactions were performed. As described above, a unique identifier can be stored as a cookie. Cookies can be deleted from user devices, such as by a user deleting cookies, a browser deleting cookies (e.g., upon browser exit, based on a browser preference setting), or some other software (e.g., anti-spyware software) deleting cookies.

If cookies are deleted from a user device, a new cookie will be set on the user's device when the user visits a web page (e.g., the search system 112). The new cookie may be used to store a new quasi-unique identifier, and thus subsequent user interaction data that occurs on the user device may be associated with a different identifier. Therefore, because each user identifier is considered to represent a different user, the user interaction data associated with the deleted cookies are identified as being associated with a different user than the user interaction data that is associated with the new cookies.

For instance, in the example above, assume that the user deletes cookies after the first search query for “tennis” is performed and that the second search query for “Brand-X” occurs after the cookies are deleted. In this example, performance measures computed based on the user interaction data for the user can show a bias. For example, a path length measure can be computed as one, rather than two, since the advertisement selection resulting from the first search query is not considered part of the same conversion cycle as the advertisement selection resulting from the second search query, since the two user interactions do not appear to have been performed by the same user.

To view a report which reduces bias caused from partial conversion paths, an advertiser can specify a lookback window for the report. As described above, the lookback window specifies that the user interaction data used to generate the report are user interaction data that are associated with unique identifiers that have initialization times that are prior to a specified period (e.g., thirty days, sixty days, ninety days) before the conversions. Thus, conversions for which user interaction data that are associated with unique identifiers having initialization times that are after the specified period are excluded from inclusion as a basis for the report. A unique identifier that has a recent initialization time indicates that the unique identifier may have been recently reinitialized on the user device that the unique identifier represents. Accordingly, user interaction data associated with the relatively new unique identifier may represent only a partial conversion path. Alternatively, conversions for which user interaction data that are associated with unique identifiers having initialization times that are after the specified period are included in the report. To reduce bias, any user interaction included in the conversion path that occurred after the specified period are removed from the conversion path prior to being included in the report.

Although FIG. 1 illustrates a single network 102, the environment 100 can include a plurality of communication networks and/or the plurality of communication networks can be configured in a plurality of ways (e.g., a plurality of interconnected local area networks (LAN), a plurality of interconnected wide area networks (WAN), a plurality of interconnected LANs and/or WANs, etc.). Similarly, although FIG. 1 illustrates the advertisement management system 110, the environment 100 can include any number of advertisement management systems. Other third party systems may analyze and display performance metrics managed by the advertisement management system 110 to the advertisers.

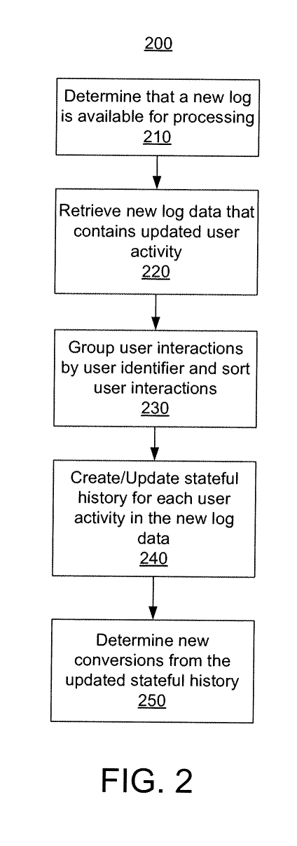

FIG. 2 is a flow diagram of a process for updating user interaction log data in accordance with an illustrative embodiment. The process 200 is a process that updates conversion paths and determines conversions based upon the updated conversion paths of users.

The process 200 can be implemented on the advertisement management system 110, the performance analysis apparatus 120, or another computing device. In one implementation, the process 200 is encoded on a computer-readable medium that contains instructions that when executed by a computing device cause the computing device to perform operations of process 200.

As described above, log files 116 may contain user interaction data. A log file 116 may be combined with user interaction data from other logs from other servers, including those that implement the search system 112, prior to processing. Processing starts with the computing device that implements the process 200 determining that a new log is available for processing (210). For example, a notification can be sent to the computing device indicating that a new log is ready for processing, or the existence of a new log can indicate that the new log is ready for processing.

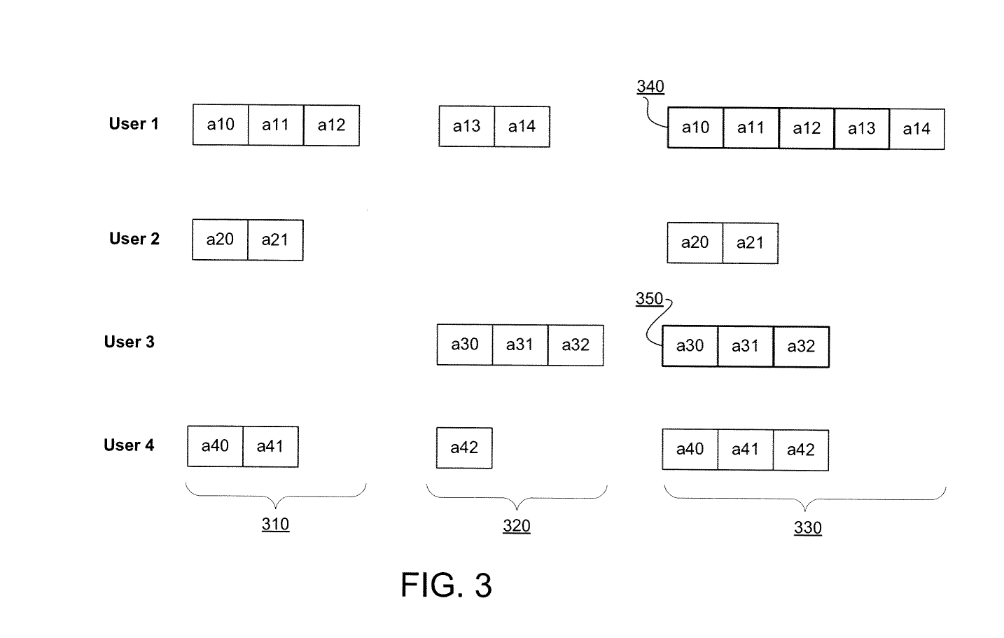

Next, the new log is retrieved (220). The new log may be retrieved over the network 102. The stateful history for each user is updated based upon the user activity indicated by the new log. The new log can contain information relating to user interactions for numerous users. The historical data store 119 contains user interaction data from previously processed log files. The user interaction data contained within the historical data store 119 can be stateful, in that the user interaction data can be grouped by user identifier and ordered chronologically. FIG. 3 is a block diagram that illustrates user interaction data being updated during a user interaction log data integration process 200 in accordance with an illustrative embodiment. FIG. 3 illustrates four example user identifiers, although the historical data store 119 and log files 116 can contain data associated with thousands or millions of different user identifiers. In one embodiment, previously stored user interaction data 310 are stored in the historical data store 119. As illustrated, no user interaction data associated with user identifier 3 has been previously stored in the historical data store 119.

The new log can contain user interaction data for one or more user identifiers. The user interaction data can be grouped by user identifiers and then sorted chronologically (230). Column 320 illustrates grouped and sorted user interaction data. As illustrated, user identifier 2 does not include any new user interaction data, and user identifiers 1, 3, and 4 have updated user interaction data. For instance, the new log file includes user interaction data associated with user interactions a₁₃ and a₁₄ that are associated with user identifier 1. The grouped and sorted user interaction data can then merged with the user interaction data stored in the historical data store 119 (240). If a user identifier previously existed in the historical data store 119, the new user interaction data are added to the previous user interaction data. Otherwise, the new user interaction data is added with a new user identifier.

Column 330 illustrates the updated user interaction data for each of the user identifiers. Based upon the updated user interaction data, any conversions that occurred in each of the updated paths of user interactions can be determined (250). User interaction paths are constrained to those user interactions that are related to a particular advertiser 108. The conversion interactions of the particular advertiser 108 are used to determine if a conversion has occurred. As an example, assume that user interactions a₁₃ and a₃₂ represent conversion interactions. Accordingly, conversion paths 340 and 350 are found. Once found, the conversion paths can be written to another portion of the historical data store 119 or another data store for further analysis.

A large number of conversion paths can be generated based on the received user interaction data. Advertisers can analyze the generated conversion paths using one or more interfaces. Using these interfaces, reports allowing for analysis of conversion paths are provided to the advertisers. In some embodiments, conversion paths can be analyzed using the path length measure. In these embodiments, conversion paths that have the same path length along with corresponding data (e.g., performance metrics such as total number of conversions, monetary value associated with a conversion path, etc.) can be aggregated into a group of conversion paths. For example, all conversion paths having a path length of “2” can be aggregated into a single group (or bucket). Various performance metrics may be determined for the created group including a total number of conversions calculated based on the total number of conversions of all the conversion paths in the group.

In some embodiments, one or more composite groups can be generated. A composite group is a logical group of several path length groups (or buckets). For example, a composite group called “2+” may be composed of conversion paths having length 2, 3, 4, and 5. In some embodiments, the advertiser may define specific composite groups that the advertiser is interested in (e.g., “All” composite group, “2+” composite group, “10+” composite group, etc.). The composite groups may be modified by the advertisers. In other embodiments, the composite groups are predetermined and preset in the advertisement management system 110. For example, if a significant number of advertisers are interested in a particular composite group (e.g., “10+”), this composite group may be displayed as a default to the rest of the advertisers, or may be offered as a default option.

The path length groups and composite groups may be provided to the advertisers for further analysis in one or more user interfaces. For example, a list of the path length groups and composite groups along with one or more aggregated performance metrics, as well as a visual presentation of the groups and performance metrics may be displayed to the user. The advertisers may select one of the path length groups or composite groups to further analyze conversions or other performance metrics associated with the selected group.

The advertisement management system 110 and/or the performance analysis apparatus 120 can be realized by instructions that upon execution cause one or more processing devices to carry out the processes and functions described above. Such instructions can comprise, for example, interpreted instructions, such as script instructions, executable code, or other instructions stored in a computer-readable medium. The advertisement management system 110 and/or the performance analysis apparatus 120 can be distributively implemented over a network, such as a server farm, or can be implemented in a single computer device.

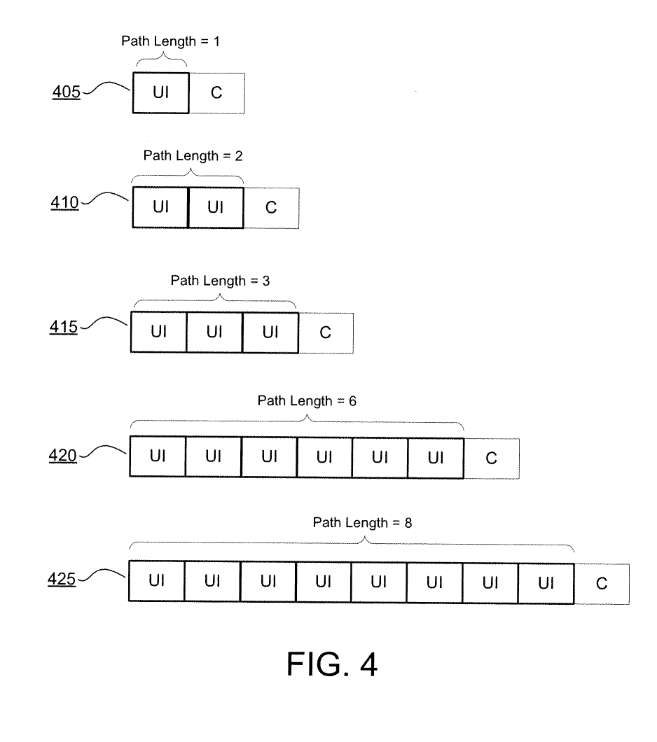

FIG. 4 illustrates exemplary conversion paths of various path lengths, according to an exemplary embodiment. In FIG. 4, five exemplary conversion paths 405, 410, 415, 420 and 425 are displayed. These conversion paths have different conversion path lengths. For example, conversion path 405 is shown to include a single user interaction and one or more interactions that constitute a conversion. As a result, the conversion path 405 has a path length of one. Conversion path 410 is shown to have a path length of two, conversion path 415 is shown to have conversion path length of three, and conversion path 420 is shown to have a conversion path length of six. Finally, conversion path 425 is shown to have a conversion path of eight. In these examples, the conversion event is not counted toward the length of the path. A user interaction may include an impression, a click, or other type of user action.

Each conversion path can have conversion path data associated with it. The conversion path data may be stored in a data store (e.g., historical data 119 or another database). The conversion path data may include a path length measure associated with a conversion path (e.g., path length equal to 6 for conversion path 420), one or more performance metrics associated with the conversion path (e.g., monetary conversion value associated with the conversion path), etc.

In some embodiments, a conversion path may include any number of user interactions. In other embodiments, a preset limit (e.g., 100 user interactions) may indicate a maximum number of user interactions that any one conversion path can include. A path length measure corresponds to the total number of user interactions occurring during a conversion cycle for a conversion. The path length can be determined for each conversion path using the number of impressions and/or clicks that are included in the conversion path. Path lengths can vary due to the price of products or services, quality of advertisements, and other reasons. For example, users may take longer to research products or services that have higher prices, or more compelling or effective advertisements may result in fewer user interactions in the conversion path.

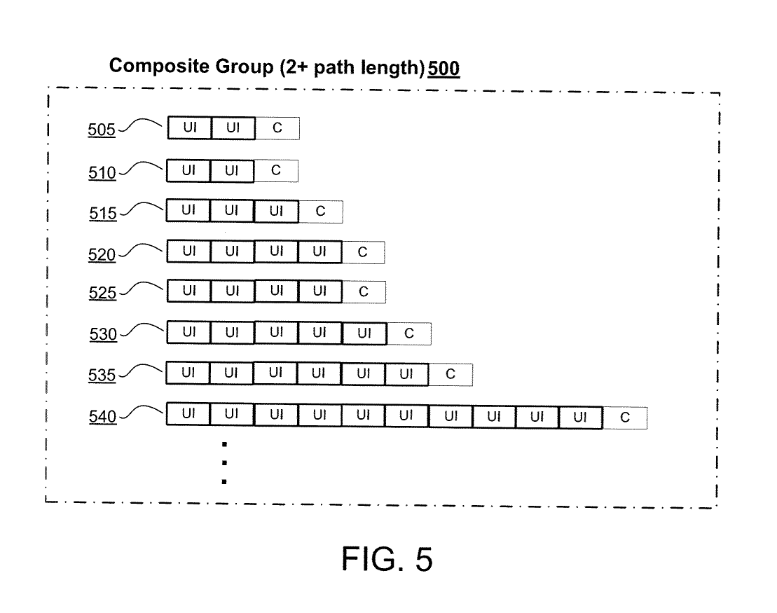

FIG. 5 illustrates an exemplary composite group 500 of conversion paths with a conversion path length equal to or greater than two, according to one embodiment. As shown, the composite group 500 includes eight conversion paths 505-540 of various path lengths. For example, conversion paths 505 and 510 have a path length of two, while conversion paths 520 and 525 have a path length four. Conversion path 540 has a path length ten.

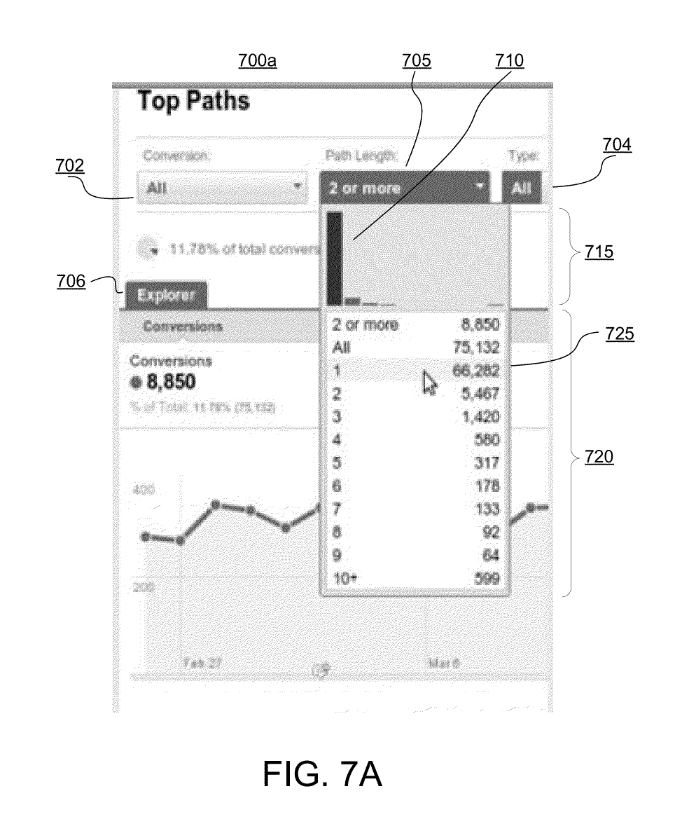

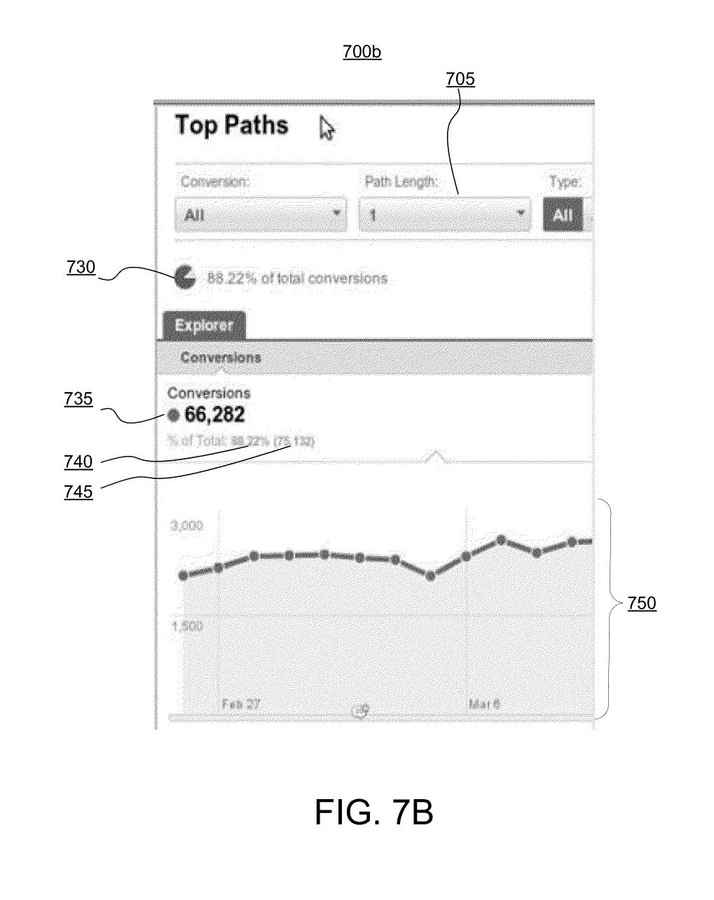

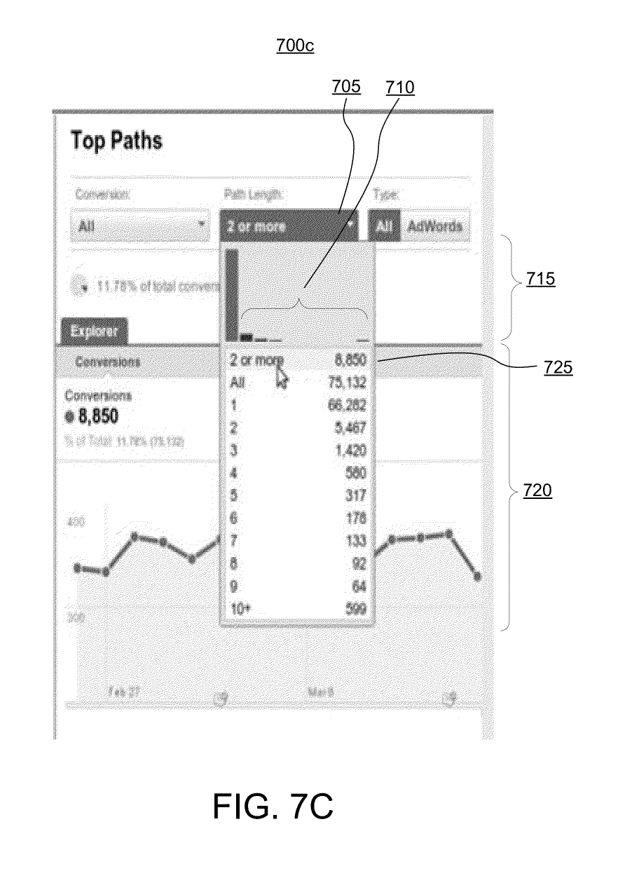

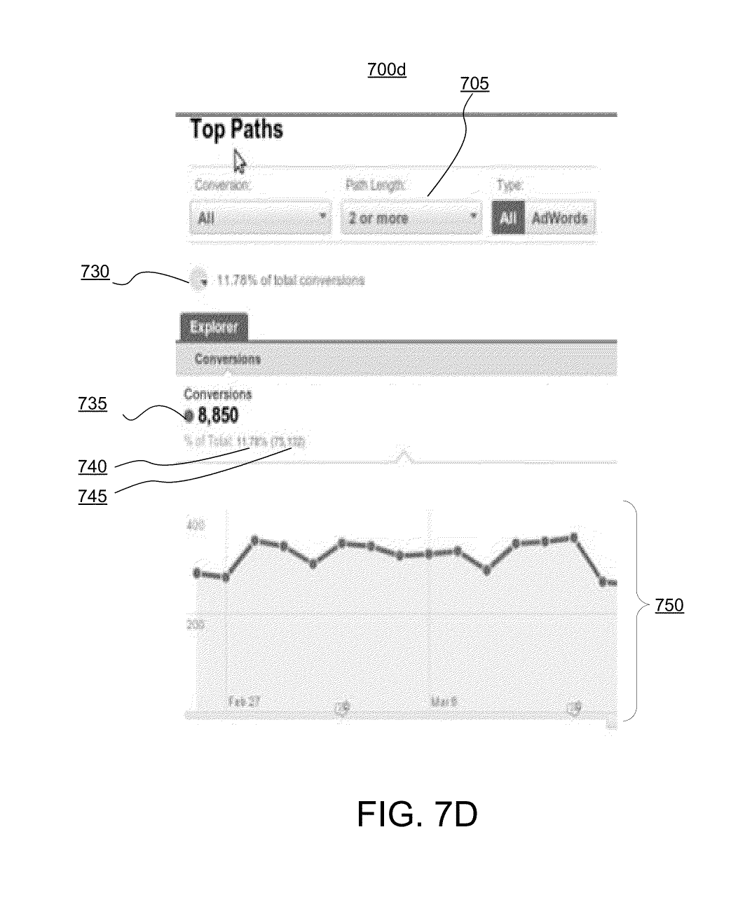

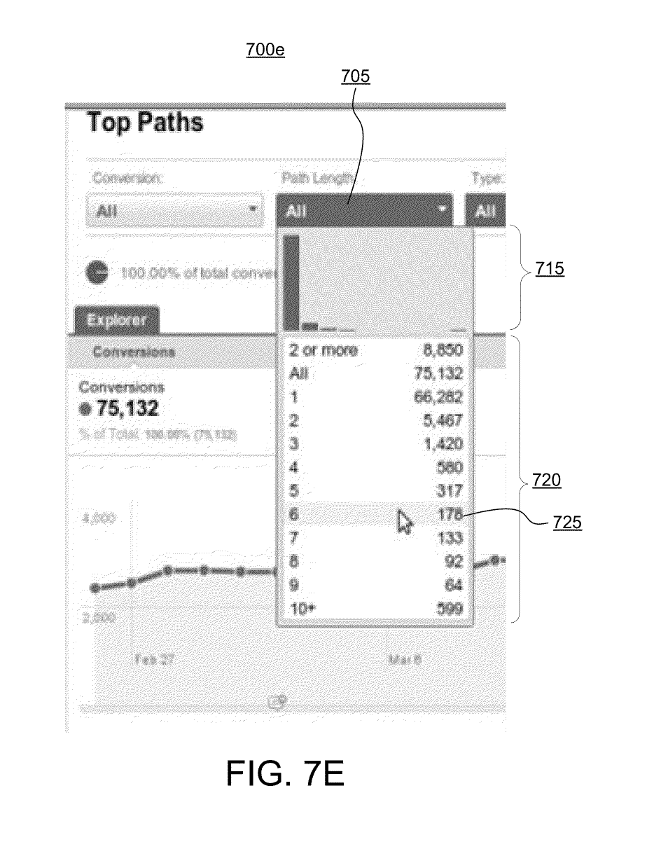

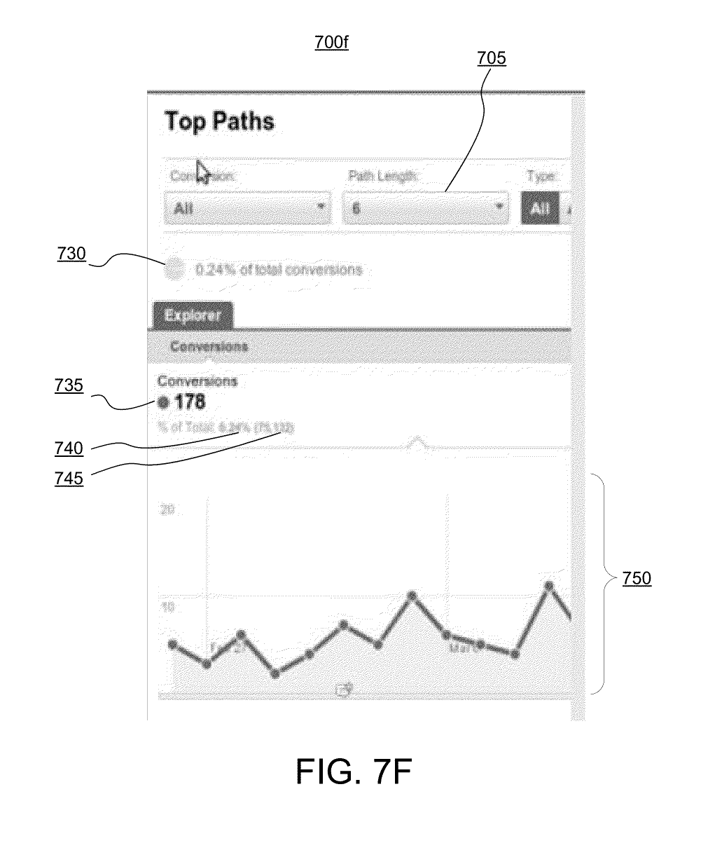

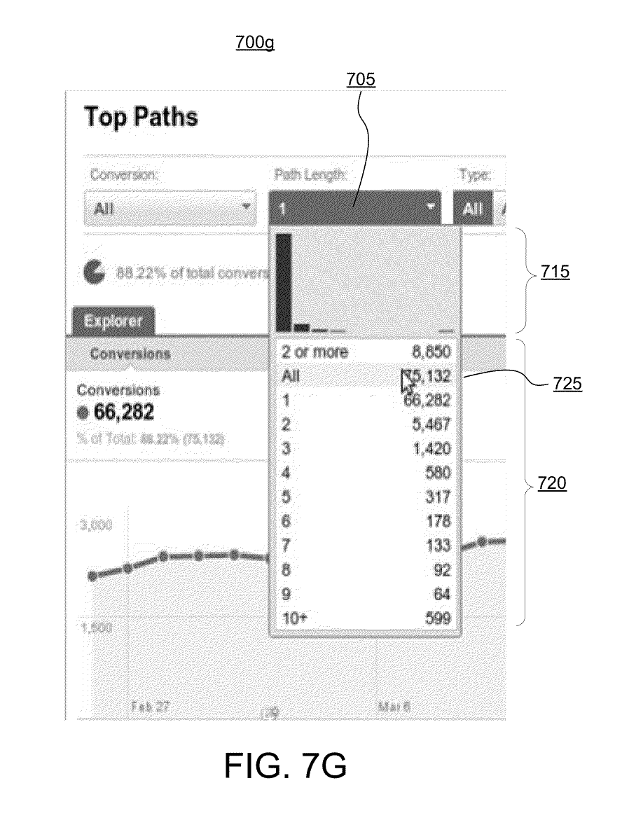

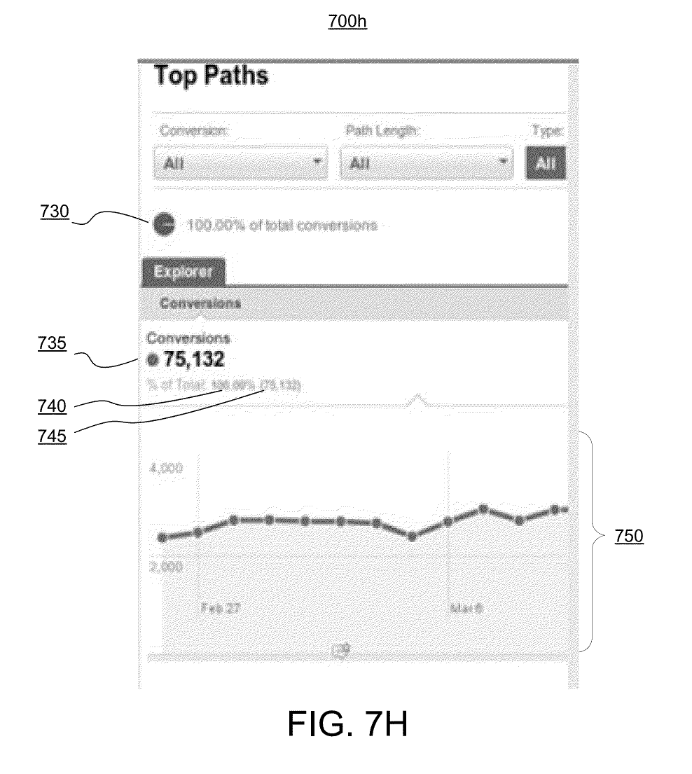

Although the composite group 500 is shown to include eight conversion paths 505-540, it can include any number of conversion paths with path length of two or greater. As illustrated in FIG. 7C, when a composite group with conversion paths with path length of two or greater are highlighted or a pointer is hovered over the composite group by the user, all the bars in the histogram with path lengths of two or greater are highlighted. These composite groups enable the advertisers to determine the most impactful lengths and as a result efficiently analyze data.

The composite groups may be created, modified, and/or deleted by the advertisers. In these embodiments, the advertisers can specify the path length ranges of interest for each composite group. In some embodiments, the composite groups may be predefined by the advertisement management system 110. In other embodiments, advertisers may be provided with default composite groups which they can later customize.

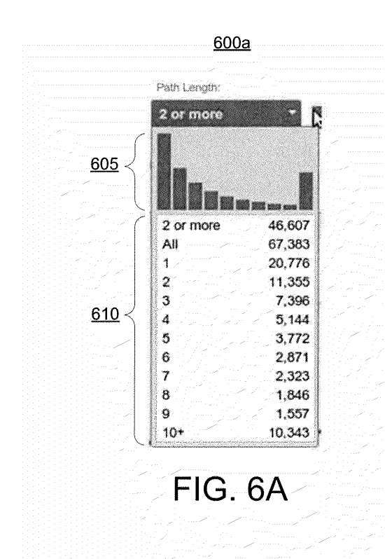

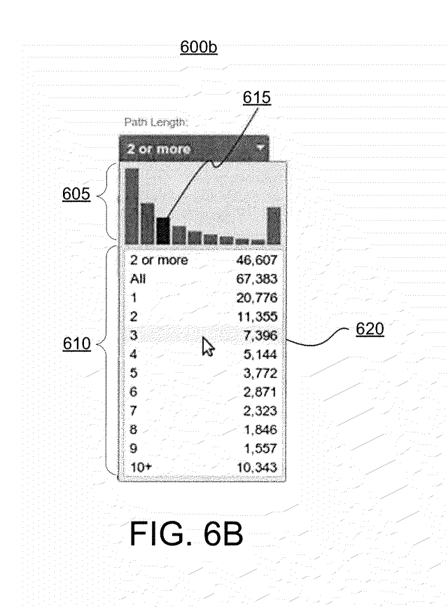

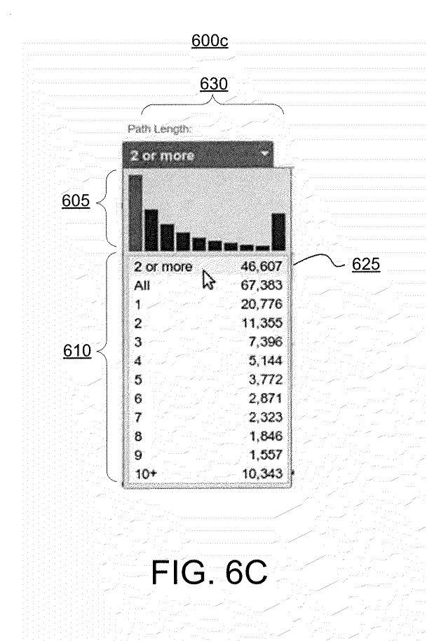

FIGS. 6A-6C illustrate exemplary user interfaces displaying path lengths available for analysis, according to one embodiment. FIG. 6A illustrates an exemplary user interface 600a illustrating a histogram 605 and a listing of various path length groups 610. The data illustrated in the user interface 600a can apply to a single advertisement campaign, multiple advertisement campaigns, specific keywords within a single advertisement campaign, a specific keyword across two or more campaigns, or any other view that a user may select. As illustrated, the listing of path length groups 610 includes paths length groups with path length “1”, “2”, “3”, “4”, “5”, “6”, “7”, “8”, and “9”, as well as three composite groups of path lengths “2 or more”, “All”, and “10+”. For each path length group and composite path length group, a total number of conversions is shown. For example, conversion paths having a path length of “1” (i.e., a conversion event following a single user interaction with online content) had a total of 20,776 conversions. Also, as shown, composite groups of several path lengths (e.g., “2 or more”, “All”, “10+”) show the total number of conversion of the underlying conversion paths. For example, the “2 or more” composite group is shown to have 46,607 conversions, which is the total number of conversions of all conversion paths that have a path length of “2” or greater.

The histogram 605 is generated using the total number of conversions displayed for each path length found in the listing of path lengths 610. The height of each bar (or bucket) in the histogram 605 shows the number of conversions associated with the path length group or composite path length group as compared to the number of conversions associated with the other bars. For example, the first bar is associated with the conversion paths that have a path length “1”. The height of the first bar corresponds to 20,776 conversion and illustrates that the greatest number of conversions took places in conversion paths with path length “1” as compared to conversion paths with other path lengths. Similarly, as visually illustrated in the histogram 605, the bar corresponding to conversion paths having path length “9” had the lowest number of conversions as compared to other conversion paths. Accordingly, the advertiser is advantageously provided with an indication of what groups of paths will result in the most plentiful amount of data to further analyze.

In some embodiments, the user can customize the path length groups and composite path length groups that are displayed in the listing of path lengths 610. For example, the user may choose to display data for path lengths “1”, “2”, “3”, “4”, and “5+”. In other embodiments, the path length groups and composite path length groups are predetermined and set automatically by the advertisement management system 110. In other embodiments, the path length groups and composite path length groups are manually set by an operator of the advertisement management system 110.

In the user interface 600a, the user has not selected or hovered over (e.g., the system has not received user input data indicating a cursor, arrow, or other graphical selection item is positioned over or upon) any of the groups of path lengths shown in the listing of groups of path lengths 610, and as a result, none of the bars in the histogram 605 are highlighted. FIG. 6B illustrates an exemplary user interface 600b displaying the same listing of path length groups 610 and the histogram 605 as was illustrated in FIG. 6A. In the user interface 600b, the user selected or hovered over a group of path lengths 620. The path length group 620 includes all conversion paths that have a path length of “3”. As a result of the user selecting or hovering over the path length 620, the user interface 600b includes a highlighted bar 615 in the histogram 605 corresponding to all conversion paths with a path length of “3”. As illustrated, the conversion paths with path length “3” had a total number of 7,396 conversions. The height of the bar 615 illustrates its relative significance (i.e., 7,396 conversions) as compared to the other bars. As a result, the user is advantageously presented with a visual comparison of conversion paths with various lengths.

FIG. 6C illustrates an exemplary user interface 600c, according to one embodiment. Similar to the user interfaces 600a and 600b, the user interface 600c displays the list of path length groups 610 as well as the histogram 605. As illustrated, the user selected or hovered over the composite path length group 625 of “2 or more”, the bars corresponding to path lengths “2”, “3”, “4”, “5”, “6”, “7”, “8”, “9”, “10+” are highlighted. Accordingly, the user can visually appreciate the significance of the composite group of conversion paths having path length of “2 or more” on the total number of conversions.

FIGS. 7A-7H illustrate screen shots of exemplary user interfaces, according to one embodiment of the present invention. FIG. 7A illustrates an exemplary user interface 700a enabling advertisers to analyze conversion path using path length. Using a path length drop down element 705, the user can view a list of path length groups 720 (i.e., groups with path length of “2 or more”, “All”, “1”, “2”, “3”, “4”, “5”, “6”, “7”, “8”, “9”, and “10+”) and a corresponding histogram 715. The histogram 715 displays a bar for each path length group in the listing of path length groups 720. Each bar in the histogram 715 visually illustrates the total number of conversions for the corresponding path length. For example, the first bar 710 corresponds to an element 725 in the listing 720. As shown in the listing of path lengths 720, the element 725 corresponds to conversion paths having a path length of “1” and a total of 66,282 conversions. As shown in the user interface 700a, the user placed the cursor over the element 725 (i.e., path length group having a path length “1”), which caused the user interface 700a to highlight the bar 710.

The user interface 700a provides advertisers with various additional elements for controlling the type of report that is displayed in the reporting section 706 of the user interface 700a. For example, a conversion type selection control 702 enables the advertiser to specify types of conversion for which the reporting section includes information. The conversion type selection control 702 can be a drop down menu with user selectable options (e.g., “All” conversion types, making a purchase, creation of user profile, downloading of files, etc.). A type control 704 allows advertisers to filter the data they are viewing by origin. As illustrated, the user selected type “All” causing the user interface to display data for all conversion paths regardless of where the interactions originated. In another example, the user may select an option from the type control 704 causing the user interface to display data for conversion paths that included at least one user interaction with an advertisement displayed in search results. Although not shown in FIG. 7A, other selection controls may be provided to the user (e.g., a date range control, time lag control, etc.) to further specify data of interest.

FIG. 7B illustrates an exemplary user interface 700b presented after the user selected the path length group 725 from the listing of path length groups 720 using the path length drop down 705 as shown in the user interface 700a. The user interface 700b illustrates performance data associated with conversion paths of length “1” including a total number of conversions 735 (i.e., 66,282), a percentage of the total 730 and 740 (i.e., 88.22%), and total number of conversions 745 (i.e., 75,132) from all conversion paths. The user interface 700b also displays a line graph 750 illustrating a number of conversions on a per-time basis. This data enables the advertiser to analyze conversion path data for the particular path length and determine its impact on the total performance of all conversion paths.

Similar to FIG. 7A, FIG. 7C illustrates a user interface 700c allowing a user to select a path length from the path length drop down 705. As shown, the user hovers over a composite path length group 725 having a path length of “2 or more” and 8,850 conversions. As a result, bars 710 corresponding to conversion paths with path length of “2 or more” are highlighted to illustrate to the user the relative significance of conversion paths with conversion path length of “2 or more” as compared to the rest of the conversion paths (i.e., conversion paths with path length “1”).

FIG. 7D illustrates a user interface 700d displaying performance data associated with conversion paths having path length of “2 or more”. The illustrated performance data includes a total number of conversions 735 (i.e., 8,850 conversions), a percentage of total conversions 730 and 740 (i.e., 11.78%) and total number of conversions 745 for all the conversion paths (i.e., 75,132). The user interface 700d also includes a line graph 750 displaying number of conversions over time. Although only February and March conversion data is illustrated, other months may be shown. In other embodiments, conversion data in the bar graph 750 may be shown on a daily basis, annual basis, etc.

FIG. 7E illustrates a user interface 700e allowing a user to select a path length from the path length drop down 705. As shown, the user hovers over path length group 725 with path length of “6” and total of 178 conversions. As a result, a bar corresponding to conversion paths with path length of “6” is highlighted to illustrate to the user the relative significance of conversion paths with conversion path length of “6” to the rest of the conversion paths. However, because there were only 178 conversions with conversion paths having path length “6”, the bar corresponding to the path length group 725 is not visible in the histogram 715.

FIG. 7F illustrates a user interface 700f displaying performance data associated with conversion paths having path length of “6”. The illustrated performance data includes a total number of conversions 735 (i.e., 178 conversions), a percentage of total conversions 730 and 740 (i.e., 0.24%) and total number of conversions 745 for all the conversion paths (i.e., 75,132). The user interface 700f also includes the line graph 750 displaying number of conversions on a monthly basis. Although only February and March conversion data is illustrated, other months may be shown. In other embodiments, conversion data in the bar graph 750 may be shown on a daily basis, annual basis, etc.

FIG. 7G illustrates a user interface 700g allowing a user to select a path length from the path length drop down 705. As shown, the user hovers over a composite path length group 725 with path length of “All” and 75,132 conversions. The composite path length group 725 is a grouping of all the conversion paths of all lengths. Accordingly, all the conversion paths are included in the composite path length group 725, and all the bars are highlighted in the histogram 715.

FIG. 7H illustrates a user interface 700h displaying performance data associated with all the conversion paths with various path lengths. The illustrated performance data includes a total number of conversions 735 (i.e., 75,132 conversions), a percentage of total conversions 730 and 740 (i.e., 100%) and total number of conversions 745 for all the conversion paths (i.e., 75,132). The user interface 700f also includes the line graph 750 displaying number of conversions on a monthly basis.

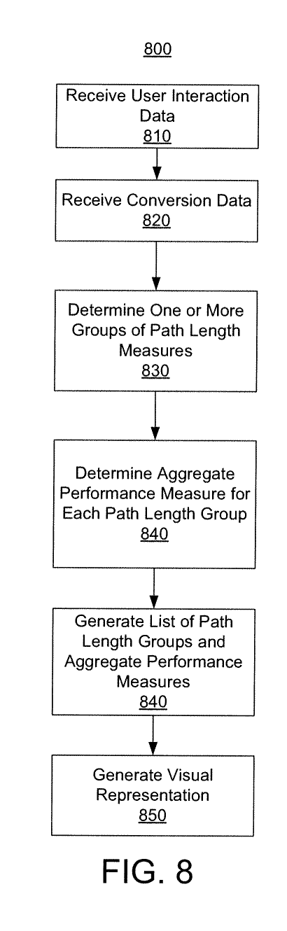

FIG. 8 is a flow diagram illustrating a process, employed by the advertisement management system 110 of FIG. 1 for facilitating generation of performance data using path length measures, according to one embodiment. The process 800 can be implemented on the advertisement management system 110, the performance analysis apparatus 120, or another computing device. In one implementation, the process 800 is encoded on a computer-readable medium that contains instructions that when executed by a computing device cause the computing device to perform operations of process 800.

At block 810, user interaction data is received from a data source. The data source can be the historical data 119, or a database maintained by the advertisement management system 110, or another system. In some embodiments, the user interaction data may specify user interaction with content items and conversion items, which are user actions that satisfy one or more predetermined conversion criteria (e.g., user purchase, creation of new account, etc.). User interaction data can represent all user interactions prior to a conversion. Content items can include advertisements that are presented with search results, text advertisements, etc. User interactions can include presentation of content items (i.e., impressions) and user selections (i.e., clicks) of content items. In some embodiments, the user interaction data may be limited to user interactions that occurred within a predetermined period of time (e.g., one week) before the conversion.

The received user interaction data may include user interactions with content items provided by a single advertiser. For example, the advertiser identifier along with the advertiser's user interaction data may be stored in a data store (e.g., historical data 117). In other embodiments, the received user interaction data may be associated with multiple advertisers.

At block 820, conversion data, including conversion path data for a plurality of conversion paths, is received. The conversion data may correspond to one or more users, and one or more advertisement campaigns managed by one or more advertisers. Each conversion path includes user interaction data prior to and including a conversion event. Conversion path data may also include a path length measure for each conversion path in the plurality of conversion paths. For example, conversion path data for a conversion path having a path length of “6” (e.g., conversion path 435) would include a path length measure of “6”.

At block 830, one or more groups of path length measures are determined. In some embodiments, the path length groups may be predetermined by a user or the advertisement management system. Information regarding path length groups may be stored in a data store managed by the advertisement management system 110. In other embodiments, the path length groups may be determined based on path length groups used by other advertisers.

An aggregate performance measure for each path length group is determined (block 840). The aggregate performance measure for each path length group can be determined by adding the performance measure for all the conversion paths making up each path length group. For example, for a path length group having a path length of “3”, performance measures (e.g., total number of conversions, total conversion value in dollars, etc.) of all the conversion paths with a path length of “3” are aggregated. The aggregate performance measure may be the total number of conversions for each path length (e.g., 66,282 conversions for path length “1” as shown in FIG. 6A).

A list of path length groups and corresponding aggregate performance measures is generated (block 840). For example, the list of path length groups may include nine groups (e.g., a group with conversion paths with a path length “1”, group with conversion paths with path length “2”, etc.). In some embodiments, one or more composite path length groups are generated with each composite path length group including two or more path length groups. For example, composite path length groups may include conversions with path lengths of “2 or more”, “10 or more”, “All”, etc. FIG. 5 illustrates an exemplary composite path length group 500 with conversion paths having path lengths of “2 or more”. In these embodiments, the aggregate performance measure is determined for each path length group based on the total aggregate performance measure of the corresponding path length groups. For example, as illustrated in FIG. 6A, the total number of conversions (i.e., aggregate performance measure) for the composite path length group “2 or more” is 8,850. In this example, the total number of conversions is a sum of all the conversions of all the conversion paths having path length “2 or more”.

A visual representation of the list of path length groups and corresponding aggregate performance measures is generated (block 850). The visual representation may be graphical, such as a histogram, a pie chart, a line graph, or any other type of visual representation. The list of path length groups and corresponding aggregate performances measures, as well as the visual representation may be presented to a user on a user interface. For example, FIGS. 5A-5C, 6A, 6C, 6E, 6G illustrate a listing of path length groups (e.g., listing of path length groups 620 in FIG. 6A) along with total number of conversions (e.g., there were 66,282 conversions with conversion paths of path length “1”), and a histogram 615.

The list of path length groups and corresponding aggregate performance measures may be ordered by path length measure in ascending order or descending order. The list of path length measures may include composite path length groups which may be listed in the beginning of the list, end of the list, or scattered through the list. In some embodiments, the order of elements in the list of path length groups is predetermined or manually set by an operator of the advertisement management system 110. In other embodiments, the advertiser can determine the order of the path length groups in the list.

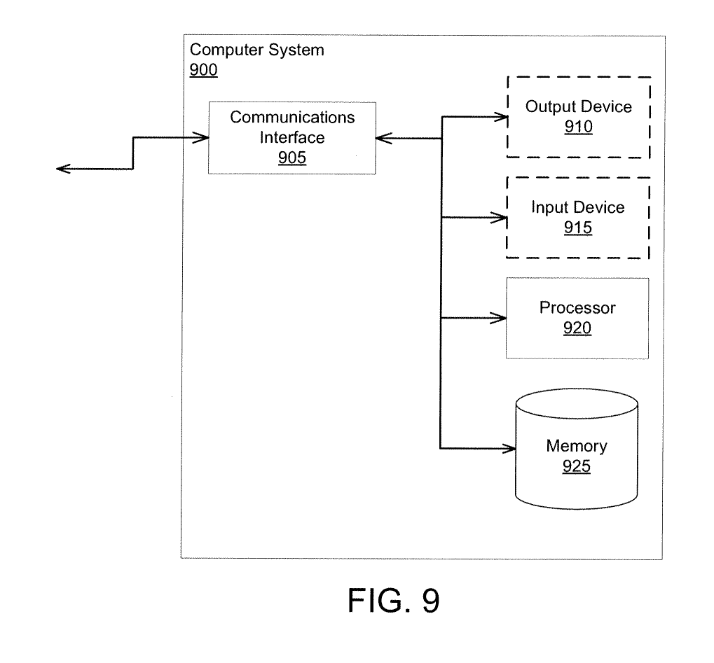

FIG. 9 shows the general architecture of an illustrative computer system 900 that may be employed to implement any of the computer systems discussed herein (including advertisement management system 110 and user devices 106) in accordance with some embodiments. The computer system 900 can be used to provide user interaction reports, process log files, implement an illustrative performance analysis apparatus 120, or implement an illustrative advertisement management system 110. The computer system 900 of FIG. 9 comprises one or more processors 920 communicatively coupled to memory 925, one or more communications interfaces 905, and optionally one or more output devices 910 (e.g., one or more display units) and one or more input devices 915.

In the computer system 900 of FIG. 9, the memory 925 may comprise any computer-readable storage media, and may store computer instructions (also referred to herein as “processor-executable instructions”) for implementing the various functionalities described herein for respective systems, as well as any data relating thereto, generated thereby, and/or received via the communications interface(s) or input device(s) (if present). Referring again to the system 100 of FIG. 1, examples of the memory 925 include the historical data 119 of the advertisement management system. The processor(s) 920 shown in FIG. 9 may be used to execute instructions stored in the memory 925 and, in so doing, also may read from or write to the memory various information processed and or generated pursuant to execution of the instructions.

The processor 920 of the computer system 900 shown in FIG. 9 also may be communicatively coupled to and/or control the communications interface(s) 905 to transmit and/or receive various information pursuant to execution of instructions. In particular, the communications interface(s) 905 may be coupled to a wired or wireless network, bus, or other communication means and may therefore allow the computer system 900 to transmit information to and/or receive information from other devices (e.g., other computer systems). While not shown explicitly in the system of FIG. 1, one or more communications interfaces facilitate information flow between the various elements/subsystems of the environment 100. In some implementations, the communications interface(s) may be configured (e.g., via various hardware components and/or software components) to provide a website as an access portal to at least some aspects of the computer system 900. Examples of communications interfaces 905 include user interfaces (e.g., web pages) accessed by advertisers to track performance of advertisements.

The optional output devices 910 of the computer system 900 shown in FIG. 9 may be provided, for example, to allow various information to be viewed or otherwise perceived in connection with execution of the instructions. The optional input device(s) 915 may be provided, for example, to allow a user to make manual adjustments, make selections, enter data or various other information, and/or interact in any of a variety of manners with the processor during execution of the instructions. Additional information relating to a general computer system architecture that may be employed for various systems discussed herein is provided at the conclusion of this disclosure.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for providing data related to conversion paths, the method comprising:
receiving user interaction data, wherein the user interaction data specifies user interaction with content items and conversion items, wherein a conversion item is a user action that satisfies a predetermined conversion criteria;
receiving conversion data including conversion path data for a plurality of conversion paths, wherein each conversion path includes user interaction data prior to and including a conversion event, and wherein conversion path data includes a path length measure for each conversion path in the plurality of conversion paths;
determining, using a processor, one or more groups of path length measures;
determining, using the processor, an aggregate performance measure for each path length measure group; and
generating, using the processor, a list of the one or more groups of path length measures and corresponding aggregate performance measures.

2. The method of claim 1, further comprising providing instructions to display the list of the one or more groups of path length measures.

3. The method of claim 2, wherein the instructions to display the list of the one or more groups of path length measures include instructions to display a graphical representation based upon the list of the one or more groups of path length measures and corresponding aggregate performance measures.

4. The method of claim 1, wherein the list of the one or more groups of path length measures and corresponding aggregate performance measures is ordered by path length measure in ascending order.

5. The method of claim 3, wherein the graphical representation is a histogram.

6. The method of claim 1, wherein the aggregate performance measure is a total number of conversions.

7. The method of claim 3, further comprising
generating one or more composite path length groups, wherein each composite path length group includes two or more groups of path length measures; and
determining the aggregate performance measure for each composite path length group based on the total aggregate performance measure of the corresponding groups of path length measures.

8. The method of claim 7, further comprising
providing instructions to display the one or more composite path length groups and corresponding aggregate performance measures.

9. The method of claim 1, wherein the conversion data corresponds to multiple users.

10. At least one non-transitory computer readable storage medium encoded with processor-executable instructions that, when executed by at least one processor, perform a method for providing data related to conversion paths, the method comprising:
receiving user interaction data, wherein the user interaction data specifies user interaction with content items and conversion items, wherein a conversion item is a user action that satisfies a predetermined conversion criteria;
receiving conversion data including conversion path data for a plurality of conversion paths, wherein each conversion path includes user interaction data prior to and including a conversion event, and wherein conversion path data includes a path length measure for each conversion path in the plurality of conversion paths;
determining one or more groups of path length measures;
determining an aggregate performance measure for each path length measure group; and
generating a list of the one or more groups of path length measures and corresponding aggregate performance measures.

11. The non-transitory computer readable storage medium of claim 10, the method further comprising providing instructions to display the list of the one or more groups of path length measures.

12. The non-transitory computer readable storage medium of claim 11, wherein the instructions to display the list of the one or more groups of path length measures include instructions to display a graphical representation based upon the list of the one or more groups of path length measures and corresponding aggregate performance measures

13. The non-transitory computer readable storage medium of claim 10, wherein the one or more groups of path length measures and corresponding aggregate performance measures are ordered by path length measure in ascending order.

14. The non-transitory computer readable storage medium of claim 12, wherein the graphical representation is a histogram.

15. The non-transitory computer readable storage medium of claim 10, wherein the aggregate performance measure is a total number of conversions.

16. The non-transitory computer readable storage medium of claim 10, wherein the method further comprising
generating one or more composite path length groups, wherein each composite path length group includes two or more path length measures; and
determining the aggregate performance measure for each composite path length group based on the total aggregate performance measure of the corresponding path length measures.

17. The non-transitory computer readable storage medium of claim 10, the method further comprising:
providing instructions to display the one or more composite path length groups and corresponding aggregate performance measures.

18. The non-transitory computer readable storage medium of claim 10, wherein the conversion data corresponds to multiple users.

19. An apparatus for providing data related to conversion paths, the apparatus comprising:
at least one communications interface;
at least one memory to store processor-executable instructions; and
at least one processor communicatively coupled to the at least one communications interface and the at least one memory, wherein upon execution of the processor-executable instructions, the at least one processor:
receives user interaction data, wherein the user interaction data specifies user interaction with content items and conversion items, wherein a conversion item is a user action that satisfies a predetermined conversion criteria;
receives conversion data including conversion path data for a plurality of conversion paths, wherein each conversion path includes user interaction data prior to and including a conversion event, and wherein conversion path data includes a path length measure for each conversion path in the plurality of conversion paths;
determines one or more groups of path length measures;
determines an aggregate performance measure for each path length measure group;
generates a list of the one or more groups of path length measures and corresponding aggregate performance measures; and
provides instructions to display the list of the one or more groups of path length measures including instructions to display a graphical representation based upon the list of the one or more groups of path length measures and corresponding aggregate performance measures.

20. The apparatus of claim 19, wherein the graphical representation is a histogram.
